(19) United States
(12) Patent Application Publication
(10) Pub. No.: US 2005/0271083 A1
(43) Pub. Date: Dec. 8, 2005

(54) High-speed Ethernet satellite bridge

(75) Inventor: James Harold Spinoso, Huntsville, AL (US)

Correspondence Address: FLESHNER & KIM, LLP, P.O. BOX 221200, CHANTILLY, VA, 20153, US

(73) Assignee: SES Americom, Inc.

(21) Appl. No.: 11/130,230

(22) Filed: May 17, 2005

Related U.S. Application Data
(60) Provisional application No. 60/575,837, filed on Jun. 2, 2004.

(51) Int. Cl. H04B 7/212; H04L 12/28

(52) U.S. Cl. 370/466; 370/401

(57) ABSTRACT

A high-speed Ethernet-satellite bridge transmits large-size data files faster and more efficiently than terrestrial networks conventionally used for this purpose. The bridge is formed by a distribution center which converts the data files from an Ethernet format into a synchronous (e.g., HSSI) format. The HSSI data is then transmitted to a satellite, where it is then multicast to a plurality of receiving sites. The receiving sites convert the data back into Ethernet data for delivery, for example, to one or more end users. The large-size data files may include digital television data, cinema data, or streaming video as well as other data.

### CROSS-REFERENCE TO RELATED APPLICATIONS

This application claims benefit of provisional U.S. Patent Application No. 60/575,837, filed Jun. 2, 2004, the contents of which are incorporated herein by reference.

### BACKGROUND OF THE INVENTION

1. Field of the Invention

This invention generally relates to systems and methods for performing data communications.

2. Description of the Related Art

Terrestrial data networks do not efficiently transfer large amounts of information (e.g., data files, multimedia, internet content, etc.) between geographic sites. This is largely due to limited bandwidths and the inherent limitations of their communication protocols. The slow performance of terrestrial data networks becomes especially pronounced when used to transfer information to multiple sites, e.g., in so-called multicasting applications.

The Internet is one example of such a network. The Internet transmits data based on a communications protocol known as TCP/IP. As those skilled in the art appreciate, TCP/IP uses several protocols that require interactive “handshaking” messages to be transmitted between network components, e.g., servers. This handshaking process detracts from the efficiency of large file transfers and is the principal contributor to slow data downloads.

This is especially true for large data files in the 200 to 300 gigabyte, e.g., files in this size range typically require several hours of transfer time because of the inefficiencies associated with the TCP/IP handshaking process. This so-called “loading” operation can stress terrestrial systems and slow performance for all users on the network. NASA was recently confronted with this problem when it attempted to transfer several gigabyte-sized files over existing an OC-3 ATM network.

Commercial media providers also experience this frustration when attempting to transmit digital television signals (HDTV) to thousands or even millions of subscribers simultaneously over conventional land-based networks.

In view of the foregoing considerations, it is clear that there is a need for an improved system and method for transmitting information (and especially very large-size data files) between sites in a communication system.

### SUMMARY OF THE INVENTION

An objective of the present invention is to provide a system and method for transmitting information (and especially very large-size data files) between sites in a communication system with improved performance in terms of efficiency and/or accuracy compared with conventional systems and methods.

Another objective of the present invention is to achieve the aforementioned object by at least partially bypassing terrestrial networks when concurrently broadcasting large data files, media content, Internet-related or other information to multiple geographic locations, for example, in a multicasting application.

Another objective of the present invention is to achieve one or more of the aforementioned objects by providing an Ethernet-satellite bridge for communicating information without requiring the interactive handshaking and/or other processing operations that substantially underlie the inefficiencies of terrestrial data networks.

Another objective of the present invention is to provide redundant systems and/or error correction techniques for backing up one or more of the aforementioned systems and methods, to thereby ensure the accuracy and reliability of information transmissions.

These and other objectives and advantages of the present invention may be achieved by providing a communication system which, according to one embodiment, serves as a high-speed Ethernet-satellite bridge. The system includes a distribution center having a first network circuit which outputs a Gigabyte-size data file in Ethernet format through a gigabit Ethernet port, a first converter which converts the Gigabyte-size data file from the Ethernet format into a High-Speed Serial Interface (HSSI) format, a modulator which modulates the data file in HSSI format based on a predetermined modulation technique, and a transmitter which transmits the modulated data in at least one of a plurality of predetermined satellite frequency bands. In one application, the modulator may output the data as DVB frames.

The system also includes a plurality of receiving sites which at least substantially simultaneously receive the transmitted data along a respective number of downlinks coupled to a satellite. Each of the receiving sites includes a demodulator which demodulates the received data to output data in HSSI format, a second converter which converts the data in HSSI format into data in Ethernet format, and a second network circuit which outputs the data in Ethernet format to one or more end users.

The system further includes a terrestrial channel between the first network circuit and a second network circuit. The channel may preferably serve as a redundant back-up link for re-sending lost packets from the first network circuit to the second network circuit. This link may be passed through the Internet or another land-band network, e.g., a virtual private network, a wide-area network, a wireless communications network, or an optical data network. In performing its redundant function, the channel re-sends lost packets to the second network circuit preferably in response to a request transmitted to the first network circuit.

The first network site may be a server or router which includes or otherwise accesses datacast software for formatting the data file. This software may allows the data transmitted to the satellite to more easily be re-transmitted to the receiving sites as multicast data. Unicast transmissions may also be performed if desired. The data may include digital television data, video-on-demand data, cinema data, broadcast data (e.g., from a television network), real-time streaming data for delivery to end users on the internet, as well as other information. This data may be transmitted through a satellite in any one of a variety of satellite bands including but not limited to the C-band, L-band, Ka band, and Ku-band.

The high-speed Ethernet-satellite bridge may advantageously serve to extend a LAN, WAN, or other network to and/or through multiple receiving sites for concurrent communication of preferably large-size (e.g., gigabyte) data files. As a result, terrestrial networks conventionally used for transmitting data files may be substantially bypassed, thereby making the system well suited for broadcasting, multicasting, and/or unicasting data, media content, and other information.

### BRIEF DESCRIPTION OF THE DRAWINGS

FIG. 1 is a diagram showing a communication system in accordance with a first embodiment of the present invention.

FIG. 2 is a diagram showing an example of a signal path that may be used to prepare data files, media content, and/or other information for transmission on the uplink shown in FIG. 1.

FIG. 3 is a diagram showing a transmit cable pin out between an Ethernet-to-HSSI converter and a modulator in accordance with one exemplary embodiment of the present invention.

FIG. 4 is a diagram show a receive cable pin out between a demodulator and an HSSI-and-the Ethernet converter in accordance with another exemplary embodiment of the present invention.

FIG. 5 is a diagram showing an example of a signal path that may be used to process data files, media content, and/or other information received from each of the downlinks shown in FIG. 1.

FIG. 6 is a diagram showing steps included in a method for communicating data in accordance with one embodiment of the present invention.

FIG. 7 is a diagram showing a communication system in accordance with a second embodiment of the present invention.

### DESCRIPTION OF THE PREFERRED EMBODIMENTS

The present invention is a system and method for improving the speed, efficiency, accuracy, and/or throughput of information transmitted to multiple sites, preferably on a simultaneous basis. The information corresponds, for example, to data files which include but are not limited to television, video, image, and/or other multimedia information. The files may have a variety of sizes but the system and method are particularly well suited to transmitting data in the gigabyte range. Files of this type include, for example, HDTV files, digital cinema, video-on-demand programming, and/or streaming files accessible through the Internet. Other files correspond to broadcast software upgrades for transmission to distribution centers such as so-called ISP server farms.

The embodiments of the present invention are not intended to be limited to these applications. On the contrary, the system and method described herein may be used to transmit data files of any size (e.g., ones larger or smaller than the gigabyte range) and of any format. For example, in accordance with another application, commercial audio or CD files may be transmitted in MP3 or any one of a variety of other formats. One test of this application was effective in transmitting audio from one site to another in less than two seconds.

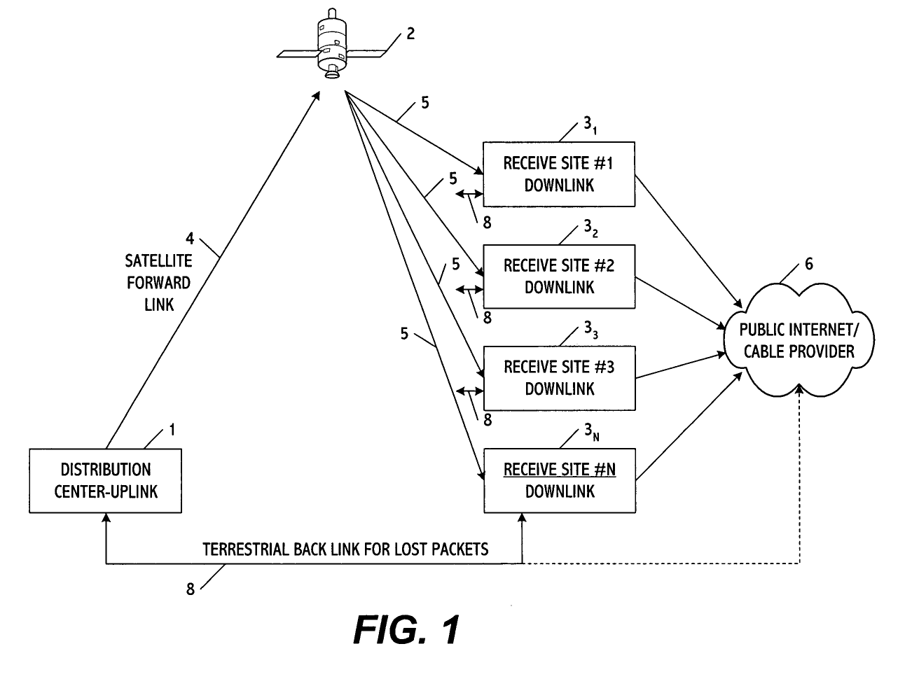

FIG. 1 shows one embodiment of the present invention, where signals are simultaneously transmitted from one site 1 to a plurality of sites 3₁, 3₂, 3₃, . . . , 3_{N} through communications equipment on an airborne or space-borne platform 2. The transmitting site may be any site (e.g., an earth station) which generates or receives from another location data files to be transmitted through the platform. This site is illustratively shown to be a distribution center, for example, of the type which transmits digital television, video, or other media files preferably in the gigabyte size range. The files may be generated from a live broadcast such as a sporting event or may be pre-recorded programming or other forms of media.

Site 1 receives the data files from a source which, for example, may be located at the transmitting site (e.g., an earth station) or which may be remotely located from and, for example, networked to the site. Site 1 also includes or is connected to an antenna for transmitting the data files on an uplink, generally shown by reference numeral 4.

The receiving sites 3₁, 3₂, 3₃, . . . , 3_{N} may be sites (e.g., earth stations) capable of receiving the data files transmitted from site 1 through one or more downlinks 5. The sites may be in different geographic locations, e.g., located regionally based on a predefined service area or globally such as when included in a television, Internet, or other content-distribution system that delivers signals to ends users in different areas, countries, or even continents. Moreover, the receiving sites themselves may be end user or subscriber sites (e.g., satellite television receivers) or ones linked to the same or different communications networks 6. In the case where the transmitted data corresponds to television signals, each receiving site may be connected to one or more respective cable television headends or distribution units. In another application (e.g., when the data files correspond to digital streaming video), each receiving site may be connected to the Internet for access on one or more websites. Those skilled in the art can appreciate that other applications are also possible.

Platform 2 may be a satellite or any other type of space vehicle. In one embodiment, platform 2 may be any one of a variety of geosynchronous satellites included but not limited to ones in the current fleet of A200, SB2000, SB3 000, SB4000, LS1300 and LM Series 3000/4000 satellites orbiting the Earth. The communications circuits on the satellite include at least one transponder with a bandwidth sufficient to transmit signals of a predetermined size and tuned to at least one specific frequency band. Most typically, the frequency band is the C-band, L-band, Ka band, or the Ku-band, although other bands may just as easily be used. A processor may be coupled to the transponder to perform signal processing functions required, for example, to perform error detection and correction, multiplexing, modulation/demodulation, encryption, coding, and/or re-transmission operations.

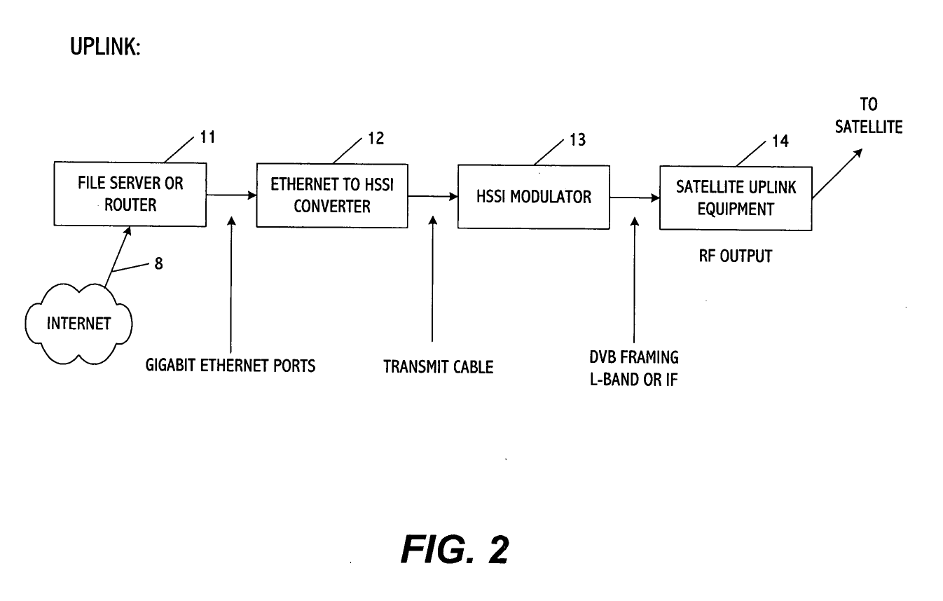

FIG. 2 shows an example of a signal path in distribution center 1 that may be used to process the signals transmitted along the uplink. This signal path includes a server or router 11, a converter 12, a modulator 13, and uplink equipment 14. The server/router may operate as a client agent which receives data from a remote source or which generates or otherwise stores the data for transmission. The server/router may also receive signals from a terrestrial back channel 8, for example, in TCP/IP format or another format. This back channel is discussed in greater detail below.

If from a remote source, the data may be received, for example, through a local area network or wide area network interface coupled to the data source. Such an interface may be but is not limited to an Ethernet interface used to carry signals optical or electrical. If optical, the interface may be any one of a variety of digital standards, e.g., OC-3. Alternatively, the server/router may receive the signals through a wireless interface, a T-3 line, or a SONET-ring connection. In addition to these features, the server/router may include a 10 MB/100 MB Ethernet return to the source or transmitting entity.

If generated or pre-stored at site 1, the server/router may be included in a local area network or wide area network. The data would then be in or transformed to a corresponding protocol. Such a protocol may correspond, for example, to any one of a variety of Ethernet standards including but not limited to IEEE 802.3, Fast Ethernet or 100BASE-T, or the so-called Gigabit Ethernet or 10-Gigabit Ethernet standards. Ethernet data of this type may be carried to or within the transmitting site by optical fiber or other suitable communication media. This site also includes or is connected to an antenna for transmitting the data on an uplink, generally shown by reference numeral 4.

The converter receives the data from the server/router preferably through one or more gigibit Ethernet ports, and then transforms the data from its Ethernet format into another format prior to transmission on the link. The other format may be a synchronous format, such as a High-Speed Serial Interface (HSSI) format capable of achieving fast data rates, e.g., 52 Mbps or greater. HSSI operates at the physical layer using the standard Open Systems Interconnection (OSI) mode, and allows for the transmission of the data (e.g., LAN frames) through the satellite uplink and downlink using a serial modem.

The conversion to HSSI format may be performed, for example, by a Metrodata LH 1000 module. This module converts Ethernet data files from the router/server into HSSI format using High-Level Data Link Control (HDLC) as the transport mechanism. HDLC is advantageous because it provides a group of protocols or rules for managing the transmission flow and pacing of data (organized into frames or packets) between network points. In this case, the network points may correspond to LAN- or WAN-based transmitting site 1 and the multiple receiving sites 3₁, 3₂, 3₃, . . . , 3_{N} Converters of this type are also advantageous because they are capable of performing format conversions at, for example, a 100 Mbps rate with extremely low overhead

Frame integrity during transmission may be ensured by performing one or more error detection/correction techniques, including but not limited to forward error checking (FEC) or frame check sequence (FCS). FCS involves appending extra characters to data frames prior to packet transmission. In the present embodiment, a 16-bit FCS may be appended to data frames either in the converter or in any circuit block thereafter.

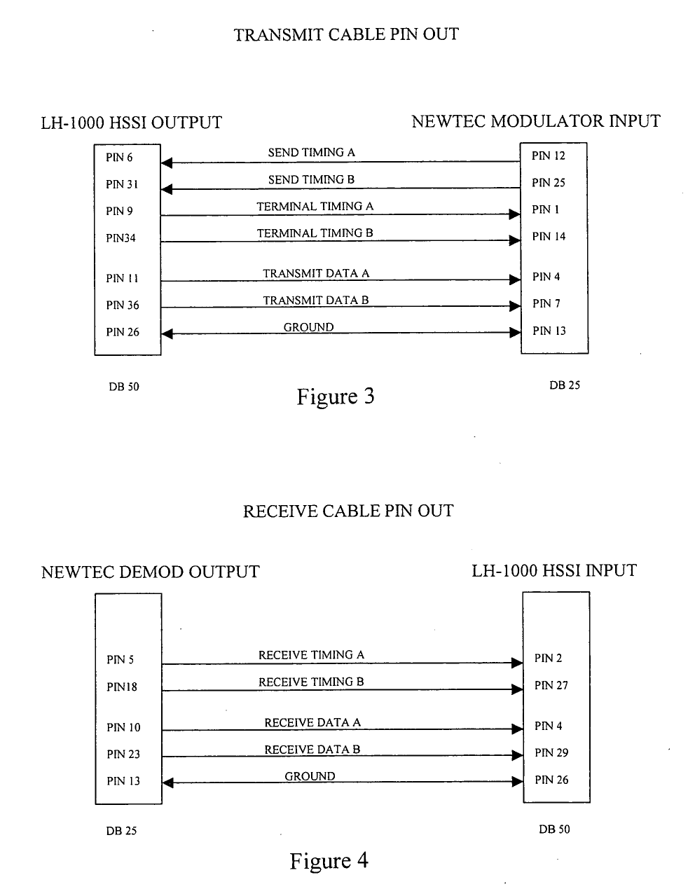

The Metrodata LH1000 includes a known 50-pin interface for performing the Ethernet-to-HSSI format conversion. This interface is coupled to the modulator prior to transmission. The modulator may be, for example, an NTC-2177 HSSI modulator manufactured by NewTec. A non-limiting example of the wiring and pin assignments that may be used to couple the LH100 to this NewTec modulator is shown in FIGS. 3 and 4. Using these pin assignments, the modulator may output HSSI data at, for example, a rate of 95 Mbps. Other bit rates are also possible.

The modulator is configured to modulate the data output from the converter based on a carrier signal in a predetermined frequency band. The modulation may be any type conventionally known for transmitting satellite signals including but not limited to quadrature amplitude modulation (QAM).

Preferably, the modulator performs 16 QAM 7/8 modulation. This type of modulation involves taking a predetermined number of bits (e.g., 4 bits) of digital information at a time from a serial data stream and then representing those bits as one symbol. Each symbol may be described as a phase and amplitude shift applied to a carrier signal.

The “7/8” fraction refers to the Forward Error Correction (FEC) ratio. This type of error correction involves inserting parity bits into the data stream before it is transmitted to the satellite. The satellite receiver or demodulator removes the parity bits and applies them to an algorithm. The algorithm, or decoding schemes (which may be Trellis coding in accordance with one aspect of the invention), corrects bit errors encountered during transmission. In 7/8 scheme, seven of every eight bits corresponds to payload data and one bit is a parity bit. The 16 QAM 7/8 modulation may be performed, for example, by the NewTec NTC-2177 HSSI modulator previously mentioned, which can advantageously achieve fast data rates (e.g., 95 Mbps).

The output of the modulator is preferably set to correspond to a desired frequency band. As a non-limiting example, FIG. 2 shows that the output of the modulator is compatible with Digital Video Broadcasting (DVB) frames. DVB frames correspond to a digital broadcasting standard used in many countries throughout the world, and for compliance purposes associated equipment for processing these signals has also been developed. This equipment may be used along the signal paths at the transmitting and receiving sites. It is further noted that DVB is only one of many digital broadcasting standards into which the data files transferred by the present invention may be processed. Other standards include the ATSC standard. In addition, or alternatively, the modulator output may correspond to an IF signal to be up-converted to carrier frequency in the next processing block.

The satellite uplink equipment may convert the modulated data into RF signals using multiple up-conversions. Multiple up-conversion techniques involve converting the data from baseband to an intermediate frequency (IF) signal and then converting this signal up to the carrier frequency. Conventional methods may be used to perform these techniques. Also, conversions of the data on the satellite uplink and downlink may be performed by dividing and then multiplexing the signals in the manner disclosed, for example, in pending U.S. patent application Ser. No. 10/213,105, the contents of which are incorporated herein by reference. The up-conversion either to carrier or IF frequency may alternatively be performed in the modulator.

The satellite uplink equipment also includes an antenna (e.g., an 11-meter parabolic) for transmitting the modulated data to the satellite. The number and type of signals transmitted preferably depend on the number of transponders in the satellite and their operating characteristics, e.g., bandwidth, the frequency band to which the transponder is tuned, etc. In one scenario, the satellite may include one transponder operating at 36 MHz bandwidth and tuned to the C-band for performing, for example, half-duplex communications. In other scenarios, the satellite may have two or more transponders with the same or varying bandwidths, tuned to the same or varying frequency bands. When configured to receive the multiplexed signals generated in co-pending application Ser. No. 10/213,105, the satellite may have two transponders each with 36 MHz of bandwidth.

The satellite also includes all necessary equipment for receiving and re-transmitting the data. For example, in accordance with one embodiment, the satellite may include equipment for modulating, demodulating, re-transmitting, and/or performing error detection and correction of the received data.

Alternatively, the satellite equipment may merely operate as a transmission path or “bent pipe,” e.g., one that forms a so-called “one to many” transmission system. In this case, the equipment may operate as an RF frequency translator in the sky, converting data signals received from the ground at one frequency or within one frequency band to one or more other frequencies or frequency bands for transmission to the receiving sites. The management and coordination of the data file transmissions may be performed by software at the uplink site and the receiving sites. The transmit version of this software may reside on the file server at the transmission site, and a receive version of the software may reside in a server at each receiving site. One type of software that can perform these functions is IDC's Datacast software (discussed in greater detail below), which uses a modified UDP TCP/IP protocol to manage the transmission and reception of data through the satellite.

The receiving sites receive the same data files transmitted from the distribution center, preferably concurrently or at least substantially so taking into consideration in the different path lengths of the downlinks. The files are received and then processed through signal paths having processing components which may be complementary to those at the transmitting site.

In a multicasting broadcast application, each receiver site may receive the transmissions by being tuned to a common satellite transponder. This may be accomplished, for example, in the same way satellite video distribution is performed. The uplink site may broadcast the data to all the receiving sites at the same time or at different times if desired. In accordance with this embodiment, the term “multicasting broadcast” may refer to transmission of the same data to all the receiving sites at the same time. In other embodiments, different multicasting schemes may be used.

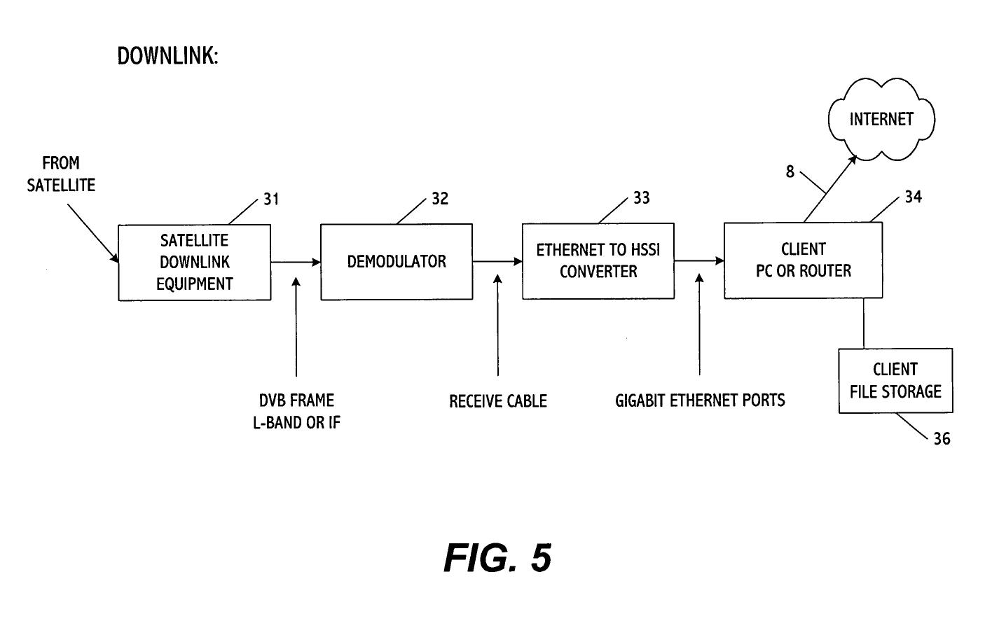

FIG. 5 shows an example of a signal path which may be included at each receiving site to process the downlink signals. The signal path includes satellite downlink equipment 31, a demodulator 32, a converter 33, and client computer or router 34.

The satellite downlink equipment includes an antenna tuned to the downlink frequency band for receiving the signals transmitted through the satellite. The antenna is coupled to equipment which down-converts the received signals either to an intermediate frequency or to baseband frequency. If down-converted to an IF frequency, the demodulator, for example, may perform a second conversion to baseband. The down-conversions may be performed using known techniques. For illustrative purposes, the output of equipment 31 is shown as corresponding to DVB frame data in the L-Band, or an IF signal.

The demodulator preferably performs the inverse form of modulation applied by modulator 13. For example, demodulator 32 may demodulate signals which have been modulated using 16 QAM modulation. These signals may be compatible with the DVB standard or another digital broadcasting standard, residing at either baseband or IF frequency. Moreover, the demodulated signals preferably correspond to a synchronous format, e.g., HSSI. A non-limiting example of a demodulator that can output signals in this format is the NTC/2163 variable-rate demodulator manufactured by NewTec. The NewTec modulators and demodulators (e.g., satellite modems) operate, for example, at 100 Mbps which is considered desirable for some applications. Different modems and/or data rates may be used for other applications.

The converter transforms the data output from the demodulator to a predetermined format which, for example, may correspond to any one of a variety of local area network or wide area network protocols. If the data output from the demodulator is in HSSI format, then converter 33 may convert the data into any one of the Ethernet standards previously mentioned. A conversion of this type may be performed, for example, by a Metrodata LH 1000 module. This module is a dual converter, in that it also converts data in HSSI format into Ethernet data which may be output, for example, from one or more gigibit Ethernet ports to the client computer or router/server.

During this conversion process or at any other point along the downlink signal processing path, incoming data packet integrity may be checked using any of the error detection and correction techniques previously mentioned. For example, a 16-bit FCS technique may be used to strip good data packets from their appended bits before they are forwarded to the Ethernet port. If the appended bits indicate an error, the corresponding packet may be discarded. These techniques are well known to those skilled in the art.

The client computer/router may store or archive the data output from the converter, or may format the data (e.g., append header information) for transmission through a network (e.g., LAN, WAN, Internet, etc.) or cable provider 6. The data may be stored within the client computer/router or in a storage device 36 coupled to the computer/router. The client and host computers may be coupled within their respective signal paths through, for example, SCSI interfaces.

A terrestrial back link channel 8 may also be included in the communication system as an optional but desirable feature. This link may be uni- or bi-directional and may be used for a variety of purposes including redundant back-up to the data files transmitted through platform 2. This back-up ensures that packet loss in file transfers are minimized. Error notification and checking functions may also be implemented through this link. Structurally, the back link may form a channel in a packet transmission network having a transport layer operating according to any one of a variety of protocols (e.g., ATM, Frame Relay, etc.) or channel-multiplexed systems. If data network is the Internet, TCP/IP may be used as the communication protocol for the back link channel.

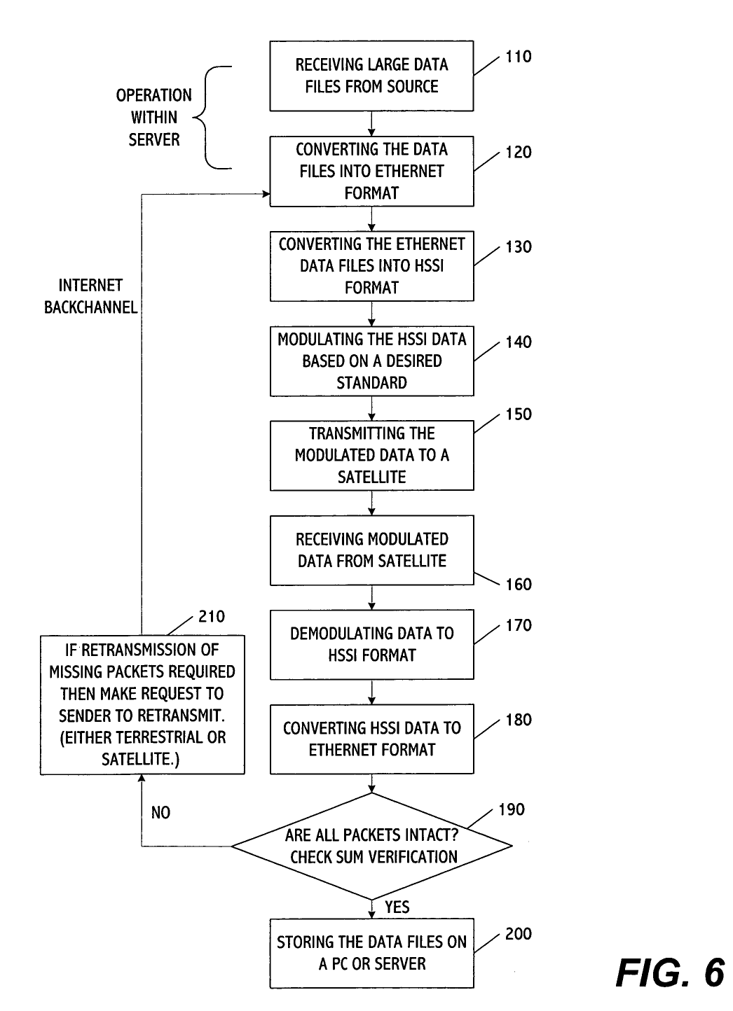

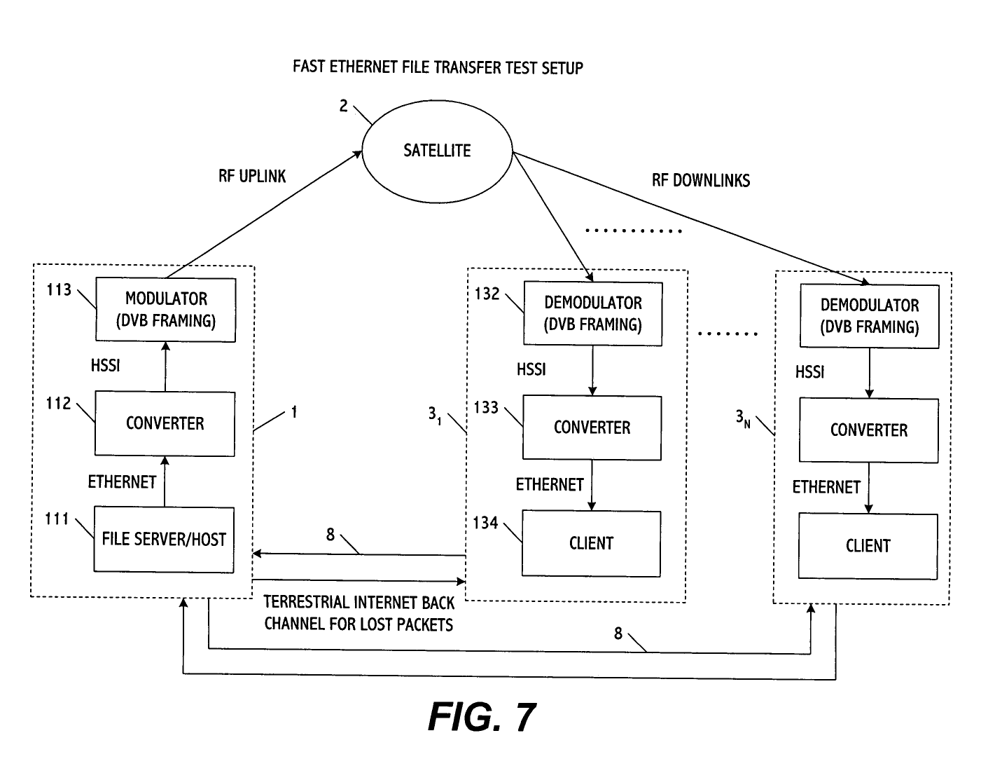

FIG. 6 is a flow chart showing steps included in a method for transmitting data files in accordance with one embodiment of the present invention. The method is preferably implemented using the system shown in FIG. 1, however other communications systems may also be used.

Initially, the method includes receiving data files from a source located at a transmitting site or remotely located from and coupled to the site through a network such as a LAN, WAN, or the Internet. (Block 110). The data files may be video, television, cinema, or image files or any of the other forms of data previously discussed. The files may also be received in analog or digital form. If received in analog form, router/server may include or be coupled to an analog-to-digital converter to place them into digital form. Moreover, if the data files constitute, for example, a stream of video or programming, a divider may be included in or coupled to the server/router to divide the data into data files of one or more predetermined sizes.

Once the data files are received or otherwise accessed, they are converted into a desired format. (Block 120). In one embodiment, the files are received in another format from the source and converted into an Ethernet format. In another embodiment, the files may be received or accessed in Ethernet format. The files are then converted from the Ethernet format into a synchronous format such as HSSI. (Block 130). This conversion may be performed in the same manner as previously explained with reference to FIG. 2. In other embodiments, conversion to a different format may be performed. If desired, Blocks 110 and 120 may be performed entirely within the file server/router on the transmitting side, or these functions may be performed in different units.

The converted data is then modulated to be compatible with a transmission standard. (Block 140). The modulation may be performed in the same manner as discussed with reference to FIG. 2. And then, the modulated signals are converted to RF signals and transmitted through the uplink. (Block 150). The satellite receives and then re-transmits the signals to multiple downlinks. (Block 160).

Each downlink signal is then down-converted and demodulated into, for example, signals in HSSI format. (Block 170). These signals are then converted into another format for transmission on a LAN, WAN, or the Internet for receipt, for example, by a cable television headend or other entity. (Block 180). The other format may be an Ethernet format.

Optional steps include checking whether all data packets in the signal transmission have been received in tact. (Block 190). This may be performed, for example, using a check sum verification procedure performed within the client computer/router. If this verification procedure indicates that all packets have been received, then the data packets may be reconstituted into data files and/or otherwise stored in memory, e.g., file storage 36. (Block 200).

If the verification procedure indicates that all packets have not been received (e.g., there are missing packets or ones received in error), the client computer/router may transmit a request to the server/router on the transmitting side to re-send the missing packets or the packets received in error. (Block 210). The request may be transmitted through the terrestrial back channel previously discussed, or using another technique or channel type. The back channel may be a 56 Kbps link or one having a different data rate. Blocks 190, 200, and 210 may, for example, all be performed in the client computer/router.

FIG. 7 shows a second embodiment of a data communications system of the present invention. This system represents a specific application of the system of FIG. 1 for transmission of streaming media. Accordingly, like reference numerals are used where applicable. (The satellite uplink and downlink equipment have been omitted in this drawing but is assumed to be included, preferably in the same manner as shown in FIG. 1.)

In this system, datacast software is installed in the file server/host computer 11 at the transmitting site and the client computer 34 at each of the receiving sites. This software supports cross-platform transmissions (e.g., Windows, Linux, Solaris, etc.), and further may be used to manage the secure and controlled delivery of large-capacity streams over multicast-enabled networks. The datacast software, thus, allows the second embodiment of the system of the present invention to, for example, transfer file content from one Internet site to multiple Internet (e.g., subscriber sites) sites concurrently, or more generically from one source to multiple destinations, preferably in real time.

An example of datacast software that may be used with this embodiment is DataCast XD software provided by International Datacasting Corporation. This software may be considered beneficial for at least some streaming applications because it incorporates advanced application-level support for Digital Rights Management (DRM) and metrics collection, as well as the production of XML based meta-data used to publish content at remote sites. This software can also enable the transfer of data at fast rates which is considered desirable for many applications.

In operation, file server/host 111 sends file content to converter 112 in Ethernet format using the datacast software. The converter transforms the content into HSSI format, where it is then modulated into DVB frames by modulator 113 and then up-converted and transmitted as an RF signal. In this illustrative example, the transmission data rate to satellite 2 (e.g., an AMC-9, 6C, satellite providing C- and Ku-band services) may be 95 Mbps, with an 90 Mbps packet throughput. Other data/packet throughput rates are possible.

The satellite re-transmits the data to multiple receiving sites 3₁, . . . , 3_{N}, where it is demodulated into HSSI format by unit 132, converted from HSSI format to Ethernet format by unit 133, and then input into client 134. The client may be a data center or headend for re-transmitting received files to other locations, for example, through the Internet or other networks. In this embodiment, terrestrial back link 8 used for transmitting lost packets may be a 56 Kbps link, however other data rates are possible.

The second embodiment of the invention may be implemented to realize one or more of the following advantages. For example, the datacast software (implementable in all embodiments) may have relatively low impact on the client and host computers. This may be attained through highly efficient coding which minimizes the use of CPU resources of the client, to the benefit of collocated applications.

Also, a full-packet replacement algorithm may be used for optimizing multicasting of data files. This is especially advantageous for large capacity (e.g., gigabyte-sized) files and/or media content. As a further feature, variable-percentage protection may be assigned within the system on a per-file basis.

Redundant forward error correction may be delivered as appended bits or an addendum file to the transmitted data. This may eliminate the need for temporary duplication of the file image on either the host computer or the client implemeting the datacast software.

In addition to redundant FEC, the back link channel may provide confirmation of deliver of the individual files transmitted from the client site. The back channel also may be implemented to offer true guaranteed file delivery, through re-transmission of missing packets to the receiving sites. Re-transmission may be performed in response to a request signal sent to the transmitting site through the back channel, once missing packet detection has occurred. The requested packet re-transmission may optionally be broadcast or unicast back to the client, for example, over the Internet.

One or more of the following broadcast features may be realized. For example, a portion of a main broadcast channel bandwidth may be allocated dynamically, under predetermined conditions. This dynamic allocation may involve re-transmitting lost packets via a back channel or re-allocating a portion of the forward link bandwidth without disturbing an on-going active file transfer. For example, in one particular application, the client at any one of the receiving sites may use packet re-transmission to thereby cancel its own request for packets.

An example of when dynamic allocation may be used is during a weather-related outage. When such an outage occurs at the transmit site, a large loss of data packets may occur at one or more of the receiving sites. The back channel may serve as an efficient way of re-transmitting these packets to the receiving sites. This channel may be, for example, a terrestrial or satellite Internet connection. If the channel is a satellite Internet connection, the satellite uplink bandwidth may be dynamically re-allocated to re-transmit the lost packets simultaneously and without disturbing a current active file transfer. A configurable threshold for maximum acceptable re-transmits of individual packets may be set in either the client or host computers, or both, under these circumstances.

One or more of the following unicast features may be realized. For example, multiple data files may be transferred concurrently, thereby optimizing overall delivery completion time. Also, if desired, the back channel may operated in tandem with FEC techniques such that only packets that are unrecoverable using the FEC techniques may be requested for re-transmission through the channel. Further, scheduled operations through the back channel may be exploited or implemented through temporary dial-up Internet connections.

An improved resiliency to packet loss may be achieved. For example, in terms of the body or payload of the data files, any number of missing packets at the receiving sites may be retrieved (e.g., to a configurable threshold) through packet re-transmission requests sent to the back link server. In addition, file trailer and checksum verification techniques may be implemented, for example, by the datacast software. That is, datacast software in the client computer may retreive a replacement file-level checksum verification directly from the back link sever.

File reconstruction techniques may also be employed. For example, in the case of redundant file re-transmission (i.e., carousel), previous damaged copies of a file may be used to patch (e.g., transferred with) a current transmission of the file or a current transmission of a new file. This may be performed at the packet level by the datacast software in the client computer or at any other point along the signal path. For example, one or more file transmissions may be added to the scheduler original file list of the datacast software.

The systems and methods of the embodiments of the present invention, thus, effectively provide a high-speed Ethernet-satellite bridge which serves to extend a LAN, WAN, or other network, via a satellite modem and its associated uplink and downlinks, to and/or through multiple receiving sites for concurrent communication of preferably large-size data files. These embodiments advantageously bypass terrestrial networks, at least in terms of their main channels of communication, for broadcasting, multicasting, and/or unicasting data, media content, and other information. Also, through these arrangements, handshaking operations may be kept at a minimum. As a result, the capacity, speed, and efficiency of transmissions, which can be for files in the gigabyte size range or greater, represent a significant improvement over ATM and other terrestrial-based networks conventionally used for this purpose.

One implementation of the system and method, for example, may achieve file throughput transfer speeds of 80-100 Mbps. In other implementations, different transfer speeds and/or throughput efficiency percentages may be attained and set, for example, based on factors such signal processing and modulation technique, transponder bandwidth, and coding rate.

Moreover, the high-speed Ethernet-satellite bridge may be implemented less expensively than existing encapsulated transmission methods in terms of file-transfer requirements. For example, the embodiments of the present invention may be implemented with less framing overhead that conventional encapsulator transmission methods. This results in improved throughput, for example, as previously indicated.

Table 1 shows the performance achievable for three types of modulation (QPSK, 8PSK, 16QAM) for each of three transponder capacities (36 MHz, 54 MHz, 72MHz) across four different coding rates. The values 2, 3, and 4 in this table refer to the numbers of bits that may be used to perform each corresponding modulation technique. The units of “Mbps/Hz” provides a measurement of transponder efficiency. (It is noted that the values in Table 1 are merely illustrative and should in no way be held to be limiting of the embodiments of the present invention.)

TABLE 1
Reed-Solomon Factor = 0.92 Separation Factor = 1.2

Coding Rate

| | | | |
|---|---|---|---|
| r(1/2) | r(3/4) | r(5/6) | r(7/8) |

1. Mbps/Hz Transponder Capacity = 36 MHz

| | | | | | |
|---|---|---|---|---|---|
| QPSK | 2 | 27.6 | 41.5 | 46.1 | 48.4 |
| 8PSK | 3 | 41.5 | 62.2 | 69.1 | 72.6 |
| 16QAM | 4 | 55.3 | 82.9 | 92.2 | 96.8 |

2. bps/Hz Transponder Capacity = 54 MHz

| | | | | | |
|---|---|---|---|---|---|
| QPSK | 2 | 41.5 | 62.2 | 69.1 | 72.6 |
| 8PSK | 3 | 62.2 | 93.3 | 103.7 | 108.9 |
| 16QAM | 4 | 82.9 | 124.4 | 138.2 | 145.1 |

3. bps/Hz Transponder Capacity = 72 MHz

| | | | | | |
|---|---|---|---|---|---|
| QPSK | 2 | 55.3 | 82.9 | 92.2 | 96.8 |
| 8PSK | 3 | 82.9 | 124.4 | 138.2 | 145.1 |
| 16QAM | 4 | 110.6 | 165.9 | 184.3 | 193.5 |

As Table 1 shows, the high-speed Ethernet-satellite bridge provided by the present invention may fill the gap between 52 Mbps and 155 Mbps in satellite transmission requirements. This “gap” may be explained as follows. Up until the present invention, standard HSSI chips were limited to a maximum speed of 52 Mbps. The next level communication standard (using different type of electronics) begins at 155 Mbps. The 155 Mbps (OC-3) data rate requires more bandwidth than a standard domestic 36 MHz satellite transponder. OC-3 services are transported on international 72 MHz transponders. International transponders 72 MHz are in limited supply and expensive. Because of the ground equipment limitation, standard domestic 36 MHz transponders topped out at about 52 Mbps. However, one or more of the embodiments of the present invention enable IP data files to be transported up to 95 Mbps . The equipment combination used with the present invention thus may be said to “fill the transponder gap,” which heretofore was a long felt but unsolved need in the industry.

The present invention, thus, provides for high-speed file transfer through a satellite broadcast, with mechanisms (e.g., back channel) that guarantees file integrity to all receiving sites. While half-duplex embodiments have been described above, the present invention may perform full-duplex operation if desired, for example, through the inclusion of bi-directional uplink and downlink paths.

Other modifications and variations to the invention will be apparent to those skilled in the art from the foregoing disclosure. Thus, while only certain embodiments of the invention have been specifically described herein, it will be apparent that numerous modifications may be made thereto without departing from the spirit and scope of the invention.

1. A transmission system for a high-speed Ethernet-satellite bridge, comprising:
a first network circuit which outputs a Gigabyte-size data file in Ethernet format through a gigabit Ethernet port;
a converter which converts the Gigabyte-size data file from said Ethernet format into a High-Speed Serial Interface (HSSI) format;
a modulator which processes the data file in HSSI format based on a predetermined modulation technique;
a transmitter which transmits the modulated data in at least one of a plurality of predetermined satellite frequency bands; and
a terrestrial channel between the first network circuit and a second network circuit coupled to a downlink of the Ethernet-satellite bridge, said channel serving as a redundant back-up link for re-sending lost packets from the first network circuit to the second network circuit.

2. The system of claim 1, wherein the first network circuit is a server included in a local area network, which carries the Gigabyte-size data file from a data source to the server in said Ethernet format.

3. The system of claim 1, wherein the first network circuit is a router included in a network, which carries the data from a data source to the server, said router converting the data to the Gigabyte-size data file in said Ethernet format.

4. The system of claim 1, wherein the first network circuit converts data accessed from a source into the Gigabyte-size data file in said Ethernet format.

5. The system of claim 1, wherein the modulator outputs the data file in DVB frames.

6. The system of claim 1, wherein the predetermined satellite frequency bands are selected from the group consisting of the C-band, the L-band, and the Ku-band.

7. The system of claim 1, wherein the terrestrial channel is a data link on the Internet.

8. The system of claim 1, wherein the Gigabyte-size data file include digital video data.

9. The system of claim 8, wherein the digital video data includes one of HDTV data and video-on-demand programming.

10. The system of claim 1, wherein the Gigabyte-size data file includes streaming video files accessible through the Internet.

11. A high-speed Ethernet-satellite bridge, comprising:
a distribution center including:
(a) a first network circuit which outputs a Gigabyte-size data file in Ethernet format through a gigabit Ethernet port,
(b) a first converter which converts the Gigabyte-size data file from said Ethernet format into a High-Speed Serial Interface (HSSI) format,
(c) a modulator which modulates the data file in said HSSI format based on a predetermined modulation technique, and
(d) a transmitter which transmits the modulated data in at least one of a plurality of predetermined satellite frequency bands; and
a plurality of receiving sites which at least substantially simultaneously receive the transmitted data along a respective number of downlinks during a multicasting operation performed by a satellite, each of the receiving sites including:
(e) a demodulator which demodulates the received data to output data in said HSSI format,
(f) a second converter which converts the data in said HSSI format into data in Ethernet format, and
(g) a second network circuit which outputs the data in Ethernet format to one or more end users.

12. The system of claim 11, further comprising:
a terrestrial channel between the first network circuit and a second network circuit,
wherein the channel serves as a redundant back-up link for re-sending lost packets from the first network circuit to the second network circuit.

13. The system of claim 12, wherein the channel re-sends lost packets to the second network circuit in response to a request transmitted to the first network circuit.

14. The system of claim 12, wherein the channel passes through the Internet.

15. The system of claim 11, wherein the first network site includes datacast software for further formatting the data file, and wherein the plurality of receiving sites receive the transmitted data as multicast data.

16. The system of claim 11, wherein the Gigabyte-size data file includes streaming video data for delivery over the Internet.

17. The system of claim 11, wherein the modulator outputs the data file in DVB frames.

18. The system of claim 11, wherein the first network circuit is server or router coupled to a local area network, which carries the Gigabyte-size data file from a data source to the server in said Ethernet format.

19. The system of claim 11, wherein the first network circuit converts data accessed from a source into the Gigabyte-size data file in said Ethernet format.

20. The system of claim 11, wherein the predetermined satellite frequency bands are selected from the group consisting of the C-band, L-band, Ka band, and Ku-band.
